(19) United States
(12) Patent Application Publication
(10) Pub. No.: US 2002/0133568 A1
(43) Pub. Date: Sep. 19, 2002

(54) Individualized network information server

(76) Inventors: Richard A. Smith, Annapolis, MD (US); Steven H. Levine, Baltimore, MD (US); Johanna Wilson, Annapolis, MD (US)

Correspondence Address: MANELLI DENISON & SELTER PLLC, 2000 M Street, N.W., 7th Floor, Washington, DC, 20036-3307, US

(21) Appl. No.: 09/785,438

(22) Filed: Feb. 20, 2001

(51) Int. Cl. G06F 15/16

(52) U.S. Cl. 709/219

(57) ABSTRACT

A mechanism for retrieving, examining, formatting, and forwarding information content as a service to a user on an individual level. A data worker focused on the needs of an individual user of a network (e.g., a mobile device of a wireless network) sends data events to destinations so that they will query a particular data source through a data source interface module. Upon an event determined from content obtained from said data source, periodically, on demand, etc., as determined by the individual user, content data is retrieved from a data source under the automatic control of the data worker, and forwarded to the user at one or more destination. Data sources can include, e.g., web pages, databases, XML documents, and Email (IMAP) accounts, legacy relational databases, news, notes, vCalendar, etc. Information can be directed to any type destination, e.g., to Email accounts, wireless devices via a short message services, databases, or other special handlers. A filter destination forwards information (as received or as modified) to another destination(s) in accordance with, e.g., a set of rules (e.g., according to the time of day), based on content in the received information, etc. An individual user may determine how the information is presented at the destination. The infoserver may utilize JDBC, XML, XSL, RMI, SMTP, and/or other protocols for retrieving, manipulating, presenting, and/or delivering information. The infoserver provides a mechanism for converting various types of information, from various sources, into a consistent XML representation. The infoserver provides an object-oriented styles event-based notification system for alerting software components that Information should be accessed. The infoserver preferably uses XSL technology to format XML data in ways appropriate for the destination.

### BACKGROUND OF THE INVENTION

1. Field of the Invention

This invention relates to individualized information management and delivery. More particularly, it relates to individual information detection and delivery for long distance carriers, Internet Service Providers (ISPs), and information content delivery services, particularly in a wireless environment.

2. Background

Information in this the information age is paramount. Moreover, in an increasingly mobile world, the popularity of communication devices in particular, and wireless mobile devices especially, has been overwhelming.

In this environment, the need for a user to frequently access particular information (e.g., the latest weather or stock quotes from a web site, etc.) becomes more necessary.

A user may today access a particular web site to check weather, stock quotes, etc. A more interested user may repeatedly ‘refresh’ a browser accessing a web page relating to the weather, stock quotes, etc., manually determining if any change has occurred since they last checked the relevant web page. These more frequent accesses lead to increased traffic in the bandwidth between the sever containing the particular web page and the user's access device (e.g., Email account, mobile device, etc.) Unfortunately, increased traffic leads to poorer performance of the overall system, not to mention lost time of the user in repeatedly refreshing or re-retrieving source data (e.g., a web page) which has not changed from the last time it was accessed.

There is a need for an information delivery system which improves efficiency of both the user and the networked system.

### SUMMARY OF THE INVENTION

In accordance with the principles of the present invention, an individualized network information delivery system comprises a data source interface module, a data worker module, and a data event destination module. The data worker module generates data events and delivers them to the destination module. Once a destination receives a data event, it queries the data event to determine from where the data should be retrieved. The destination can use separate formatter objects to format the content. The destination module has the option of delivering directly to a device or to other destination modules. By separating the roles of data source, destination, and action initiators (‘workers’), the system becomes very flexible in design. It becomes possible to ‘hook up’ any combination of source and destination modules, and to easily configure when data transactions should take place. Since destinations can also act as sources, it is possible to route data through a series of ‘filters’ that can process the data for ultimate delivery to the end-user or application.

### BRIEF DESCRIPTION OF THE DRAWINGS

Features and advantages of the present invention will become apparent to those skilled in the art from the following description with reference to the drawings, in which:

FIG. 1 illustrates the core functionality of an infoserver with an exemplary infoserver retrieving data from any or all of a plurality of different data sources as a service provided to an individual user, e.g., mobile user, in accordance with the principles of the present invention.

FIG. 2 illustrates core functionality of an infoserver, in accordance with the principles of the present invention.

FIG. 3 is a more detailed view of an exemplary software architecture with communications shown between software modules, in accordance with the principles of the present invention.

FIG. 4 shows a generalized example describing how the components of the infoserver function, in accordance with the principles of the present invention work together.

FIG. 5 is a Unified Modeling Language (UML) class diagram showing major software elements of an exemplary infoserver system, in accordance with the principles of the present invention.

### DETAILED DESCRIPTION OF ILLUSTRATIVE EMBODIMENTS

The present invention provides a mechanism for retrieving, examining, formatting, and forwarding information content as a service to a user on an individual level. A primary function provided by the present invention is the individualized forwarding of information from one or more data sources to one (or more) user defined destination(s). This routing of information can be performed at regular intervals, whenever the source data changes, or on demand, as defined by the individual user.

In accordance with the principles of the present invention, information can be retrieved from a variety of types of data sources, including Web Pages, databases, XML documents, and Email (IMAP) accounts, legacy relational databases, news, notes, vcalendar, and more.

Information can be directed to any of a plurality of types of destinations, e.g., to Email accounts, wireless devices via a short message services, databases, or other special handlers that analyze the received data and respond in appropriate ways.

In accordance with the principles of the present invention, a destination may forward the information (as received or as modified) to another destination(s) in accordance with, e.g., a set of rules (e.g., according to the time of day), based on content in the received information, etc.

In the disclosed embodiment, an individual user is given the ability to determine how the information is presented at the destination. Potential formats include a simple user-defined message (“Hey—new data at Fred's Home Page”), to text or html-based content for particular fields of the received data.

Preferably, the infoserver uses open standards for retrieving, processing, and forwarding data. Moreover, the infoserver preferably follows the principles of interface-driven software design, enabling a high degree of flexibility when integrating with other systems. Furthermore, the infoserver may use modern object-oriented paradigms for event-driven information management.

The present invention may be implemented in a stand-alone product or as a tool for developing other Information-based applications. As disclosed, the infoserver may utilize JDBC, XML, XSL, RMI, SMTP, and/or other protocols or technologies for retrieving, manipulating, presenting, and/or delivering information. The disclosed embodiments include an application program operating on a Java-enabled server platform.

Because of its direct exposure to subscribers and to the Internet, it is preferred that the infoserver application program not reside on a service network platform. To integrate easily into different provider networks, it is preferred that the infoserver operate on any of the most common server platforms, including, e.g., Solaris (Intel/Sparc), NT, HP/UX, and/or Linux. Moreover, it is preferred that the infoserver support an open communication architecture so that other applications can communicate with it more easily.

The infoserver provides a mechanism for converting various types of information, from various sources, into a consistent XML representation. The infoserver provides an object-oriented, event-driven notification system for alerting software components that Information should be accessed.

The infoserver preferably provides a mechanism for ‘chaining’ multiple DataEventListeners, thereby allowing information to be directed to a Filter Listener and then only redirected to other Listeners if certain criteria within the Data has been met. The infoserver preferably uses XSL technology to format XML data in ways appropriate for the destination.

The infoserver can be deployed as a stand-alone application which can be utilized by custom software components, as well as a commercial-off-the-shelf (COTS) web interface for consumer use.

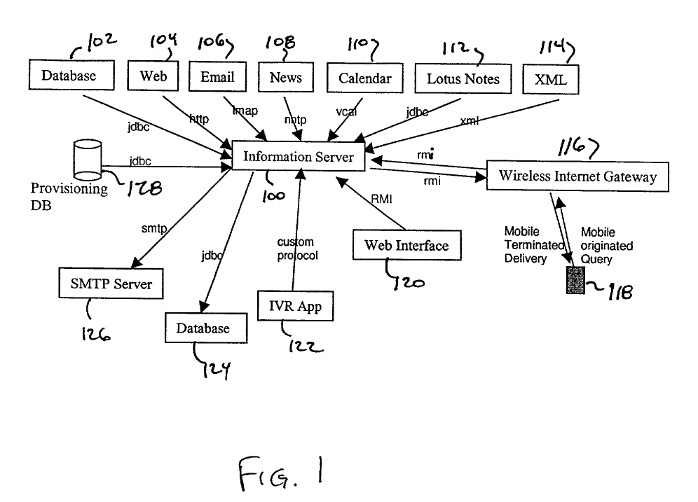

FIG. 1 shows an exemplary infoserver 100 retrieving data from any or all of a plurality of different data sources 102-128 as a service provided to an individual user, e.g., mobile user 118, in accordance with the principles of the present invention.

In particular, as shown in FIG. 1, an infoserver application 100 resides between an individual user and a desired one or more information sources 102-128. While the infoserver 100 may be provided as a separate application on a separate network device from a wireless internet gateway 116 or other accessing device, it may also be provided on a common platform with another network device, particularly in less sensitive applications.

A wireless internet gateway 116 is provided between a wireless service provider which provides access to the mobile device 118, and the information server 100. The wireless internet gateway 116 provides a buffer between a service providers network equipment (e.g., a wireless provider's network), and the devices from which information may be accessed.

A suitable wireless internet gateway is shown and described in a co-owned U.S. patent application Ser. No. 09/630,762, filed Aug. 2, 2000, entitled “Wireless Internet Gateway” by Rich Smith, the entirety of which is expressly incorporated herein by reference.

As shown in FIG. 1, in a basic implementation, the mobile device 118 requests a retrieval of information from a particular data source 102-128 using a mobile originated query.

The information server (“infoserver”) communicates data from and/or to any of a plurality of data sources 102-128 based on individual requests or individual configurations established by a particular user (e.g., mobile device 118). Possible data sources include, but are not limited to, a source database (e.g., a relational database) 102, a web page 104, an Email account 106, a news source 108, a calendar application such as vCalendar 110, a LOTUS™ Notes application 112, an XML document 114, a web interface device 120, an interactive voice response (IVR) application 122, a destination database 124, an SMTP server 126, and/or a provisioning database 128.

The different data sources 102-128 may communicate their data with the infoserver 100 using any appropriate protocol. For instance, the source database 102, LOTUS™ Notes 112, the destination database 124, and/or the provisioning database 128 may use a JDBC protocol. The web pages 104 may communicate with the infoserver using the HTTP protocol, and XML documents may be retrieved/sent using the XML protocol. The Email account 106 may communicate with the infoserver 100 using an IMAP protocol. The News source 108 may communicate using an NNTP protocol. The calendar application 110 may communicate using a VCAL protocol. The web interface device 120 may communicate using an RMI protocol, and the SMTP server 126 may communicate using an SMTP protocol.

Custom protocols are also possible, as depicted by the IVR application 122, which communicates with the infoserver 100 using a custom protocol.

Thus, data sources 202 may access information from, e.g., standard databases such as an ORACLE™ database, an INFORMIX™ database, and/or from an SQL server through JDBC. A data source 202 may also or alternatively process HTML web pages, thereby allowing a web page's core data to be expressed as XML. A data sources 202 may also query from one or more Email account(s) using, e.g., the IMAP protocol. A data source may also retrieve XML documents, or query one or more news server(s) via, e.g., the NNTP protocol. Other possible data sources 202 include a VCalendar database, a LOTUS™ Notes database, or an SNMP MIB.

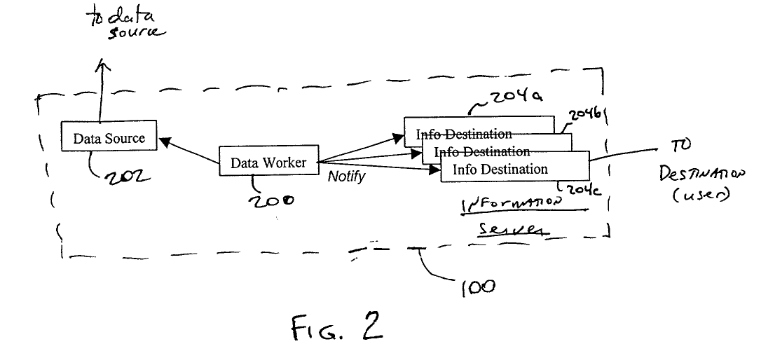

FIG. 2 illustrates core functionality of an infoserver 100, in accordance with the principles of the present invention.

In particular, as shown in FIG. 2, an infoserver 100 comprises three basic component types: one or more data source(s) 202, which provide access to information and from which information is retrieved; one or more data workers 200, which act autonomously to access data according to the user's directives, and one or more information destination(s) 204a-204c, to which information is routed.

Data sources 202 provide a mechanism for accessing disparate types of data. Regardless of where the data originates, data sources 202 convert their data to XML streams that can then be accessed by data destinations 204a-204c. The data is preferably accessed in a streaming fashion so that large quantities of data can be processed. A data stream (or streaming data) refers to information that is received and read one byte at a time, as opposed to the entire data all at once. By allowing the data to be retrieved as a byte stream, the data source 202 may be configured so that the entire data content need not be retained in memory at any single time. This is important for the implementation of very large data sets from data sources 202.

The data sources 202 can optionally provide any number of stylesheets for their data. These stylesheets may be defined in the extensible Stylesheet Language (XSL). The stylesheets define presentation specifications for the data. This allows the data source 202 to provide suggested display templates for its information. For example, a data source 202 providing stock information could provide stylesheets that define different presentation layouts for viewing the information via a pager, a web browser, or an Email client.

Data workers 200 act on behalf of the user to access one or more data sources 202 at pre-defined intervals, or as specially requested by the user. The data worker 200 fires data events to data destinations at appropriate times. The data event contains a reference to the data source that should be queried by the destination. The destination retrieves information from the data source 202. A data worker 200 can fire data events at predefined minutes, hours, days of the week, or days of the month. Data workers 200 can also be temporarily ‘turned off’ by a user if its services are not required for a time.

Data workers 200 have the ability to initiate queries on demand, regardless of the scheduled time. This allows end-users to directly request an immediate transmission of some piece of data. Such a request can be issued by 2-way pagers, handsets, or Palm devices, thereby allowing the user to obtain information on demand.

Data destinations 204a-204c are responsible for receiving the information and delivering it to a destination, such as a pager or Email account. A data destination 204a-204c queries the XML data stream from a data source 202 and optionally formats the data into a presentable format. For example, a destination for a WAP-enabled phone would format the XML data into a document using the Wireless Markup Language (WML), whereas an Email destination might format the data as formatted text or HTML.

In accordance with an important aspect of the present invention, data sources 202 are abstracted, or separated, from data destination components 204a-204c. By abstracting the data source 202 and data destination components 204a-204c into entities that communicate via XML, the infoserver can readily accommodate different types of information sources. Moreover, by implementing XSL, the various information source types can be presented in a variety of formats to accommodate many types of destination devices.

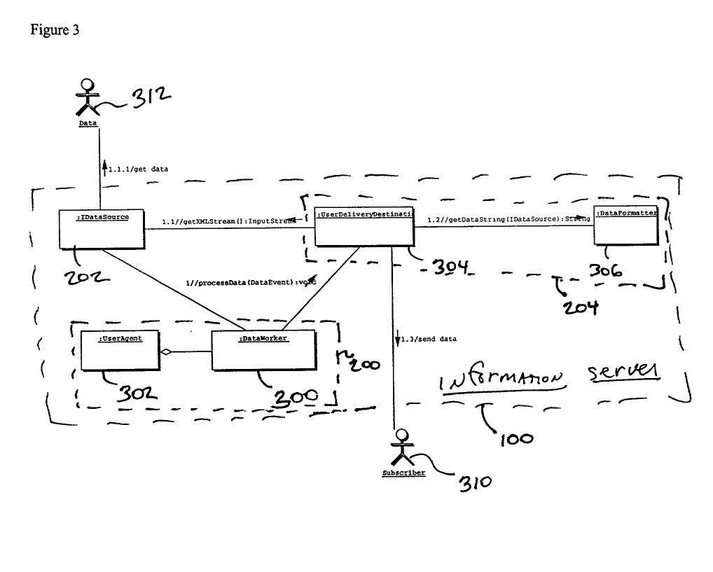

FIG. 3 is a more detailed view of an exemplary software architecture with communications shown between software modules, in accordance with the principles of the present invention.

In particular, as shown in FIG. 3, the disclosed information server 100 application program includes a dataworker module 300 and a useragent module 302 within the dataworker 200 shown in FIG. 2. The dataworker module 300 and the useragent module 302 provide the information ‘engine’ for the information server 100.

An IdataSource module 202 provides communications with the desired data source. There may be more than one IdataSource module 202 in a particular information server. Each IdataSource module 202 may be developed to handle a particular protocol. For instance, A first IdataSource module 202 may be implemented to communicate with JBDC protocols to database sources, while another IdataSource module 202 may be implemented to communicate with IMAP protocols to Email accounts, etc.

The module of the information server 100 which communicates with the info destination 204 (e.g., the mobile user) is comprised of a UserDeliveryDestination module 304 and a DataFormatter module 306.

There are two ways to support the many processes that the system must provide: centrally or de-centrally.

In a centrally managed process, a single process would attend to the unique requirements established by each user. For example, every minute it might check a database to determine if any data should be queried and forwarded for any users. For each data request that has been ‘queued up’, the central process would have to keep track of user-specific settings such as whether the service had been disabled, when the service should expire, and under what conditions data should be forwarded. This will become even more complicated as additional options are made available to the end-user.

Because the services offered by the infoserver 100 may be so tailored to individual users, a centralized processing approach is not recommended. A better approach is to make the software architecture simulate its environment. Specifically, the infoserver 100 implements a decentralized approach in which the individual users are represented as ‘living’, autonomous objects that can take care of their own affairs. There is preferably no monolithic central thread that tries to address the unique needs of each user. Rather, individual user objects run in their own threads (processes) and query data, as well as perform other tasks in the future, according to the rules specified by their individual users.

These user objects, or user agents 302 as shown in FIG. 3, are autonomous in nature. Namely, they not only operate in their own thread independently of other processes, but they can be saved and retrieved from disk and can be moved onto other host servers as required. So, if too many user objects are running on one server, user agents 302 can automatically (or manually) move onto other servers for automatic load balancing.

Taking this decentralized approach even further, there is no need for each user agent 302 to centrally monitor and control all of the services that are being performed. Rather, each individual service can be performed by its own threaded object which handles only those tasks that are assigned to it. Therefore, it is very easy to start, stop, or assign the life span of particular services. All the user need do is directly address the worker object performing the service and ask it to start, stop, or modify its life span. Preferably no other data workers 200 are affected by this transaction, and no other user agents 302 will even know that the change has occurred.

Accordingly, the two major components of the infoserver 100 are the user agents 302, which aggregate services for individual end-users, and data workers 300, which actually perform a given service for a User Agent 302.

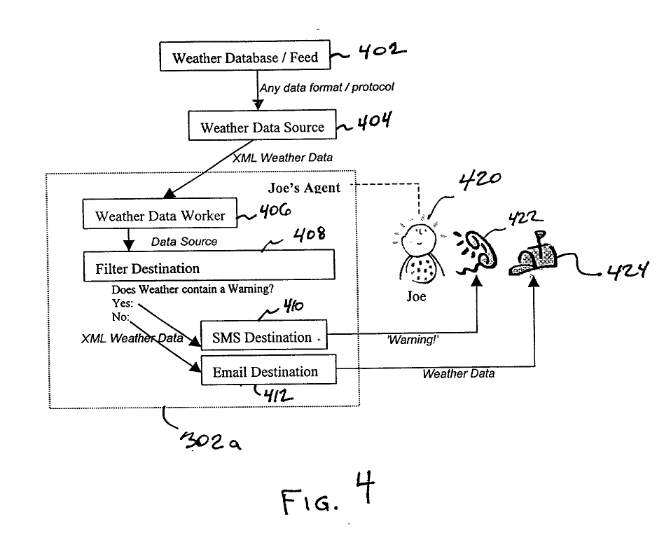

FIG. 4 shows a generalized example describing how the components of the infoserver 100 function, in accordance with the principles of the present invention work together.

In particular, as shown in FIG. 4, a particular user agent 302a for Joe performs tasks that are uniquely created for that end user. In this example, Joe's user agent 302a has an interest in tracking the weather. Joe's user agent 302a is therefore configured with objects that will help manage this requirement.

For instance, as shown in FIG. 4, a commonly shared weather data source 404 queries a local weather database/feed source 402 using any appropriate protocol for local weather. The weather data source 404 may parse the information, e.g., into ‘high temperature’, ‘low temperature’, ‘description’, and ‘weather warning’ elements and place the parsed information in a desired format in an XML document.

Joe's user agent 302 includes a data worker 300 that monitors the weather data source 404, e.g., every 4 hours, whenever the data changes, on demand, etc. Whenever the weather data worker 406 obtains data from the weather data source 404, it forwards it to a destination (e.g., SMS destination 410 or Email destination 412) chosen by the individual user/owner of the agent 302a. The destination 410, 412 evaluates the data and presents it in the appropriate manner to the user.

Two types of destinations may be made available within the InfoServer 100: simple destinations and filters. Examples of simple destinations include E-mail and short messaging systems (SMS). SMS messages are submitted through the wireless Internet gateway 116 (FIG. 1). When information is routed to a simple destination, it is preferably formatted and sent via the appropriate protocol to the destination.

In a more sophisticated and intelligent embodiment, the data (e.g., the weather data) may be first transmitted to a filter destination, where further evaluation and disposition is determined. Filters are more sophisticated destinations that actually process the information in some way and then forward it to a different destination. For instance, one type filter may be implemented which forwards information to a particular destination only if any pertinent information has changed since the last query. Another type filter may be implemented which forwards information to a particular destination only if a key condition within the information is met.

Thus, a filter destination 408 may be implemented in Joe's agent 302a to provide an intermediary analysis and to determine a final destination for the data. For instance, in the given example of FIG. 4, the filter destination 408 may evaluate the weather data XML page received from the weather data worker 406 for the presence of a ‘Warning’ indicator within the data it receives. If a warning exists, then the user-defined ‘Weather Warning!’ message may be send to the individual using a more immediate device (e.g., to their wireless handset via the SMS destination 410). On the other hand, if a warning is not associated with the received information, then, e.g., the full weather information may be sent via E-mail by transmission of the XML data page to the Email destination 412.

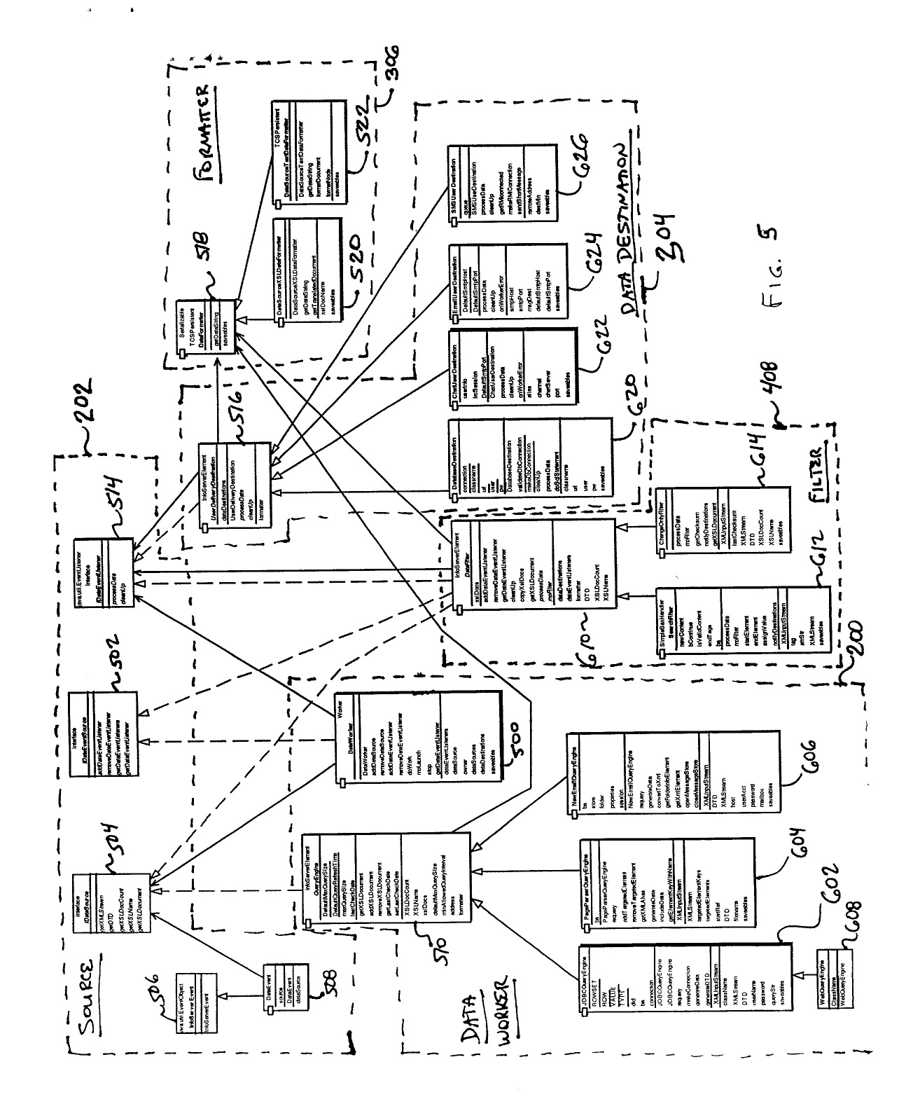

FIG. 5 is a Unified Modeling Language (UML) class diagram showing major software elements of an exemplary infoserver system, in accordance with the principles of the present invention. In FIG. 5, lines with closed arrows indicate inheritance, or a ‘specialization’ relationship to the class at which the arrow is being directed. Dashed lines with closed arrows indicate that a class is implementing the interface to which the arrow points. Lines with open arrows indicate an association, in which a class contains an instance member of the type of class to which the arrow is directed.

The exemplary infoserver operates primarily through the use of Java Interfaces, which are roughly equivalent to abstract classes in C++.

As shown in FIG. 5, a data source 202 includes a ‘IdataSource’ interface 504, an ‘IdataEventSource’ interface 502, and an ‘IdtaEventListener’ interface 514.

The data worker 200 includes a ‘DataWorker’ module 500, as well as an information analysis engine entitled ‘QueryEngine’ 510. The QueryEngine 510 may use any appropriate protocol interface to query a data source at the appropriate time. For instance, the ‘QueryEngine’ 510 may use a ‘JDBCQueryEngine’ module 602 to query databases using JDBC protocols, a ‘WebQueryEngine’ module 608 to query a web page using, e.g., HTML protocols, a ‘PageParserQueryEngine’ module 604 to parse information from an XML data stream, or a ‘NewEmailQueryEngine’ module 606 to query Email accounts.

A filter 408 may be implemented including an appropriate ‘DataFilter’ module 610, a ‘SearchFilter’ module 612 which searches for particular information in a received data stream (e.g., in an XML data stream), or a ‘ChangeOnlyFilter’ module 614 which determines if a change in a data stream has occurred since a last query. Thus, the ‘ChangeOnlyFilter’ destination 614 may be implemented to forward the information to another destination if pertinent information has changed since the last query, and the ‘SearchFilter’ destination 612 may be implemented to forward the information to another destination if a certain condition within the XML stream is met.

A data destination 304 component of the infoserver 100 includes a ‘UserDeliveryDestination’ module 516, with appropriate interface modules. Example destination interface modules include a ‘DataBaseDestination’ module 620, a ‘ChatUserDestination’ module 622, an ‘EmailUserDestination’ module 624, and an ‘SMSUserDestination’ module 626.

A ‘DataFormatter’ module 518 may format source information into, e.g., XSL or text, using an appropriate ‘DataSourceXSLDataFormatter’ module 520 or ‘DataSourceTextDataFormatter’ module 522.

The ‘DataWorker’ module 500 fires off ‘DataEvents’ 508 to the data destinations 304 when appropriate. Appropriate times can explicitly assigned by the individual user, rather than by the network administrator on a class basis. The ‘DataWorker’ module 500 may be instructed to activate at any given time or sets of times during the month, down to the minute. The ‘DataWorker’ 500 can also activate when specifically instructed, thereby providing information on demand.

Three important interfaces in the design of the exemplary infoserver 100 include the ‘IdataSource’ module 504, the ‘IdataEventListener’ module 514, and the ‘IdataEventSource’ module 502.

The ‘IdataSource’ module 504 provides XML-based information to the infoserver engines. The ‘IdataEventListener’ module 514 receives ‘DataEvents’ 508 indicating that the infoserver 100 should query an IdataSource 504. The ‘IdataEventSource’ module 502 is responsible for sending the ‘DataEvents’ 508 to the ‘IdataEventListeners’ 514.

Objects that implement these interfaces perform the work within the infoserver environment. For instance, the QueryEngine class 510 implements IDataSource 504 and acts as a base class for the Web, XML, Email, and Database QueryEngines 510, 602, 604, 606, 608 that have been produced.

The DataWorker class 500, which is a special type of Worker, implements the IDataEventSource Interface 502, as it is responsible for telling IDataEventListeners 514 when they should query from a particular IdataSource 504. When the DataWorker 500 does its work, it fires a DataEvent 508 to the IdataEventListener 514. The DataEvent 508 contains a reference to the IDataSource 504 which is to be queried by the IDataEventListener 514.

There are many possible types of IDataEventListeners 514 within the infoserver 100. For instance, a simple one is the UserDeliveryDestination 516, which is a base class for Destinations representing SMS, Email, Database transactions, etc. When a UserDeliveryDestination 516 receives a DataEvent 508, it will query the IDataSource 504 identified by the DataEvent 508 for the XML content.

The UserDeliveryDestination 516 then uses a DataFormatter 518 to format the content in an appropriate manner. For example, the data may be formatted according to an XSL template using, e.g., a DataSourceXSLDataFormatter 520, or it may simply convert the XML data in a text-based tree structure using, e.g., a DataSourceTextDataFormatter 522. Subclasses of the DataFormatter 518 are preferably able to format the XML data in different ways.

As shown in FIG. 5, four UserDeliveryDestination classes are presented. In particular, a DatabaseDestination class 620 allows delivery of content to a database destination. A ChatUserDestination class 622 allows delivery of chat postings to an IRC Chat Group. An EmailUserDestination class 624 allows delivery of email messages, and an SMSUserDestination class 626 allows delivery of short messages to a short messaging system.

The DataFilter class 610 is also shown. The DataFilter class 610 is an IDataEventListener 514 that acts as a base class for filtering rules. The DataFilter 610 is not only a DataEventListener 514, but also an IDataSource 504 and an IdataEventSource 502.

When the DataFilter 610 receives information, it is able to selectively direct that information to other destinations. For example, the ChangeOnlyFilter subclass 614 will redirect information only if the information has changed since the last time it was received. The SearchFilter subclass 612 will forward information only if certain search criteria have been met.

FIG. 5 also shows more types of QueryEngines 510. A QueryEngine is able to query, e.g., databases (via JDBC) using a JDBCQueryEngine module 602, web pages using a WebQueryEngine module 608, and/or Email accounts using a NewEmailQueryEngine module 606.

A Web-based interface may be provided for the infoserver 100 to allows the technology to be used as a turnKey mobile information service. The infoserver 100 can also be used in any number of applications that require automated manipulation of data.

Each agent may be described, e.g., by the user's name, Email address, Mobile Number, etc. Each agent can have any number of DataWorkers 500. Each DataWorker 500 has an associated IdataSource 504, as well as any number of destinations. It is possible to assign multiple IDataSources 504 to a particular DataWorker 500, but in practice this can add undesirable complexity to the system.

When appropriate, the DataWorker 500 creates a DataEvent object 508 and fires it to the destination(s) by calling the ‘processData’ method of the UserDeliveryDestination 516. The DataEvent 508 contains a reference to the IDataSource 504 that should be queried by the UserDeliveryDestination 516. The UserDeliveryDestination 516 then queries the IdataSource 504 by calling the getXMLStream( ) method of the IdataSource 504. Once it has the information, the UserDeliveryDestination 516 can deliver it appropriately.

These and other components and modules of the exemplary infoserver in accordance with a preferred embodiment of the present invention are further detailed and described in the attached APPENDIX 1, which is incorporated herein by reference.

The following provides an illustration of how the QueryNet libraries can be used.

It is not necessary for components within the infoserver to reside on the same server. With the ability to disperse components among two or more servers, the infoserver product scales well and greatly expands product deployment possibilities. For example, a ‘personal infoserver’ can be implemented as a stand-alone application that allows a subscriber to create and run data workers locally. Local data workers query a master infoserver for available data sources, and forwards the information to either local data destinations (e.g., a user's hard drive), or public data destinations such as a short messaging system (SMS). Such a distributed implementation allows information applications based on infoserver technology to interoperate over a geographically disperse environment.

Although the present invention has particular relevance to wireless distribution of information content, it is also applicable to multiple electronic distribution mechanisms.

While the invention has been described with reference to the exemplary embodiments thereof, those skilled in the art will be able to make various modifications to the described embodiments of the invention without departing from the true spirit and scope of the invention.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. An individualized network information delivery system, comprising:
a data source interface module;
a data worker module; and
a data event destination module;
said individualized network information delivery system having an event-driven architecture; and
said data worker being abstract from said data source interface module.

2. The individualized network information delivery system according to claim 1, wherein:
said data event destination module interface with a short messaging system.

3. The individualized network information delivery system according to claim 1, wherein:
said data worker is abstracted from said data event destination module.

4. The individualized network information delivery system according to claim 1, wherein:
said data worker includes a query engine.

5. The individualized network information delivery system according to claim 4, wherein:
said query engine is adapted to query a web page for content.

6. The individualized network information delivery system according to claim 4, wherein:
said query engine is adapted to query a database for content.

7. The individualized network information delivery system according to claim 6, wherein:
said query utilizes a JDBC protocol.

8. The individualized network information delivery system according to claim 4, wherein:
said query engine is adapted to query an email account.

9. The individualized network information delivery system according to claim 4, wherein:
said query engine to parse said content into a format more convenient for said data worker.

10. The individualized network information delivery system according to claim 1, further comprising:
a formatter module to format said content into XSL information.

11. The individualized network information delivery system according to claim 1, wherein:
said data event destination module provides XML information to a destination device.

12. The individualized network information delivery system according to claim 1, wherein said data source interface module comprises:
a protocol converter to convert a protocol of said source data into an XML data stream.

13. The individualized network information delivery system according to claim 12, wherein:
said XML data stream is a read by said data event destination module one byte at a time.

14. The individualized network information delivery system according to claim 1, wherein:
data from a data source communicating with said data source interface module is HTML format data.

15. The individualized network information delivery system according to claim 1, wherein:
data from a data source communicating with said data source interface module is email, said data source interface module utilizing an IMAP protocol to query an Email account as a source.

16. The individualized network information delivery system according to claim 1, wherein:
data from a data source communicating with said data source interface module is an XML format document.

17. The individualized network information delivery system according to claim 1, wherein:
a data source communicating with said data source interface module is a news server, data from said data source being communicated to said data source interface module utilizing an NNTP protocol to query said news server.

18. The individualized network information delivery system according to claim 1, wherein:
a data source communicating with said data source interface module is a Vcalendar database.

19. The individualized network information delivery system according to claim 1, wherein:
a data source communicating with said data source interface module is a Lotus database.

20. The individualized network information delivery system according to claim 1, wherein:
a data source communicating with said data source interface module is an SNMP MIB.

21. The individualized network information delivery system according to claim 1, wherein:
said data source interface module presents a data source with a stylesheet defined in an extensible Stylesheet Language (XSL).

22. An individualized network information delivery system, comprising:
a data worker module dedicated to an individual user; and
a data destination interface module;
said data worker module being adapted to generate an event listener to monitor source data at the behest of said individual user; and
said data worker being abstract from said data destination interface module.

23. The individualized network information delivery system according to claim 22, further comprising:
a data destination filter functionally between said data worker module and said data destination interface module, said data destination filter determining a characteristic of content from a particular data source, and redirecting said content from said particular data source to said individual user only if certain criteria within said content has been met.

24. The individualized network information delivery system according to claim 22, wherein:
said characteristic of said content is a change in said content.

25. The individualized network information delivery system according to claim 22, wherein:
said characteristic of said content is a change in a particular parameter of said content.

26. A method of monitoring an information source for an individual user of a network, comprising:
generating an event listener abstract from a requesting destination device of said individual user, said event listener monitoring a particular data source for an occurrence of a particular event; and
upon an occurrence of said particular event, directing content obtained from said data source to said requesting destination device.

27. The method of monitoring an information source for an individual user of a network according to claim 26, wherein:
said network is a wireless network.

28. The method of monitoring an information source for an individual user of a network according to claim 26, wherein:
said particular event is a change in content from said data source.

29. The method of monitoring an information source for an individual user of a network according to claim 26, wherein:
said particular event is a presence of a particular parameter in said content from said data source.

30. A method of monitoring an information source for an individual user of a network, comprising:
generating an event listener abstract from a requesting destination device of said individual user, said event listener monitoring a particular data source; and
automatically periodically directing content obtained from said data source to said requesting destination device.

31. Apparatus for monitoring an information source for an individual user of a network, comprising:
means for generating an event listener abstract from a requesting destination device of said individual user, said means for generating said event listener monitoring a particular data source for an occurrence of a particular event; and
means for directing content obtained from said data source to said requesting destination device upon an occurrence of said particular event.

32. The apparatus for monitoring an information source for an individual user of a network according to claim 31, wherein:
said network is a wireless network.

33. The apparatus for monitoring an information source for an individual user of a network according to claim 31, wherein:
said particular event is a change in content from said data source.

34. The apparatus for monitoring an information source for an individual user of a network according to claim 31, wherein:
said particular event is a presence of a particular parameter in said content from said data source.

35. Apparatus for monitoring an information source for an individual user of a network, comprising:
means for generating an event listener abstract from a requesting destination device of said individual user, said means for generating said event listener monitoring a particular data source; and
means for automatically and periodically directing content obtained from said data source to said requesting destination device.
